(19) United States
(12) Patent Application Publication
(10) Pub. No.: US 2012/0174333 A1
(43) Pub. Date: Jul. 12, 2012

(54) WIPER FLUID HEATER

(76) Inventor: Gordon M. Heidacker, Madison Heights, MI (US)

(21) Appl. No.: 13/344,701

(22) Filed: Jan. 6, 2012

Related U.S. Application Data
(60) Provisional application No. 61/430,336, filed on Jan. 6, 2011.

(51) Int. Cl. B60S 1/50; B60S 1/52

(52) U.S. Cl. 15/250.01

(57) ABSTRACT

An apparatus for heating windshield wiper fluid before the fluid is sprayed onto a windshield. The apparatus generally includes a fin tube assembly positioned in close proximity to or in contact with the catalytic converter of an automotive vehicle. The heat from the catalytic converter is transferred to the fin tube assembly. Wiper fluid is passed through the tube assembly and thus heated before being sprayed onto the windshield of an automotive vehicle. The system further includes a thermostat and control valve to control if and when the fluid should be passed through the fin tube for heating. Fluid is pumped from a reservoir to the control valve where a decision is made, based on external vehicle temperature, whether to bypass the heating element or to pass the fluid through the heating element for heating before spraying the fluid onto the windshield of the vehicle.

### CROSS-REFERENCE TO RELATED APPLICATIONS

This application claims priority of U.S. Provisional Patent Application No. 61/430,336 filed Jan. 6, 2011, the contents of which are incorporated herein by reference.

### FIELD OF THE INVENTION

This invention relates generally to wiper fluid systems for an automotive vehicle. More particularly, this invention relates to a system for heating wiper fluid in an automotive vehicle.

### BACKGROUND OF THE INVENTION

It is commonly known to use wipers on windshields of vehicles, boats or other like vehicles to clear the windshield of rain, spray, dirt, etc. Generally, the vehicle or boat is also equipped with a device which sprays the fluid onto the windshield to assist in cleaning dirt, salt residue, and insects. In order to prevent the fluid from freezing in colder climates, the wiper fluid typically includes glycol or other fluids which will not freeze in the cold weather. In cold climates, drivers attempt to use wipers to clear ice and sleet from the windshield. However, the wiper blade is typically ineffective until the windshield is heated and the ice or sleet begins to melt. Thus, it would be desirable to provide a device which would assist in cleaning the windshield in such conditions.

### SUMMARY OF THE INVENTION

The present invention is an apparatus for heating windshield wiper fluid before the fluid is sprayed onto a windshield. The apparatus generally includes a fin tube assembly positioned in close proximity to or in contact with the catalytic converter of an automotive vehicle. The heat from the catalytic converter is transferred to the fin tube assembly. Wiper fluid is passed through the tube assembly and is heated before being sprayed onto the windshield of a vehicle. The system further includes a thermostat and control valve to control if and when the fluid should be passed through the fin tube for heating. Fluid is pumped from a reservoir to the control valve where a decision is made, based on external vehicle temperature, whether to bypass the heating element or to pass the fluid through the heating element for heating before spraying the fluid onto the windshield of the vehicle. The heated fluid can then be used to assist in removal of ice and sleet from a windshield.

### BRIEF DESCRIPTION OF THE DRAWINGS

FIG. 1 is a schematic and perspective view of a system for heating windshield wiper fluid in accordance with the invention; and

FIG. 2 is a schematic view and top view of the heating system in accordance with the invention.

### DETAILED DESCRIPTION OF THE INVENTION

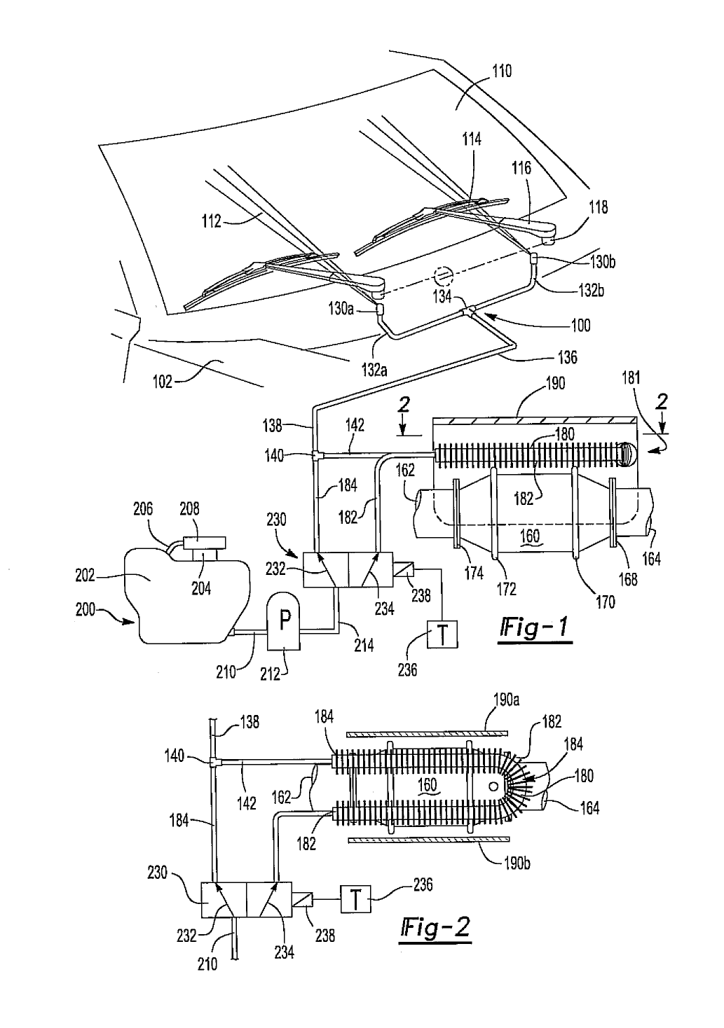

As shown in FIGS. 1 and 2, a novel system for heating washer fluid of a vehicle is shown. The heated fluid can be used to assist in removal of ice and sleet from a windshield. Additionally, it has been found that heated fluid also assists in removal of certain types of dirt such as the remains of insects. The system utilizes heat from a catalytic converter to heat the windshield fluid in a fin tube and further includes a supply from a windshield sprayer reservoir. As shown in FIG. 1, the system is connected to a conventional windshield spraying system 100 on a motor vehicle 102. The vehicle 102 includes a windshield 110 and windshield wipers 114. The windshield wipers 114 are connected to the vehicle 102 by means of the arms 116 and connectors 118. The windshield wiper system 100 typically includes a reservoir 200, a pump 212, a plurality of delivery conduits, and a spray nozzle 130a, 130b. The spray nozzle 130a, 130b directs fluid 112 onto the windshield 110 of the vehicle 102.

The present system includes a thermostat 236 with a directional valve or control valve 230 and an inlet valve 238. The thermostat 236 is connected to the control valve 230. The thermostat 236 includes a sensor which is positioned to sense the temperature of the environment surrounding the vehicle 102. In the present embodiment, the thermostat is operable to adjust the control valve 230 to control the fluid direction flow of the wiper fluid.

In the present embodiment, the thermostat is set to a predetermined temperature such as 40° F. The control valve 230 is normally open to deliver fluid from the reservoir 200 directly to the wiper system 100 as shown in directional arrow 232. The fluid is then delivered to the windshield 110 by means of the spray nozzles 130a, 130b. However, when the ambient temperature falls below 37° F., the thermostat 236 sends a signal to the control valve 230 to open the valve and allow fluid from the reservoir 200 to flow to the heating element 181. This predetermined ambient temperature can be between 30-50° F. This directional flow is illustrated by directional arrow 234 as shown on the control valve 230.

The control valve 230 is operable to open and direct fluid. The control valve 230 may be a solenoid valve. The control valve 230 diverts fluid from the fluid delivery line 214 to a conduit 182 delivering fluid to the heating element 181.

A reservoir 200 is operable to hold the wiper fluid in a tank 202. The reservoir 200 further includes a cap 208 having a neck 204. The cap is connected to the tank 202 by means of a connector 206.

Fluid from the reservoir 200 flows to the pump 212 by means of the connector and conduit 210. The pump 212 then pumps fluid through the conduit 214 to the control valve 230. After a decision as to direction flow 232, 234 is made by the thermostat 236 and the control valve 230, the fluid then passes to either the heating element 181 or directly onto the windshield 110.

If the thermostat determines the ambient temperature to be below the predetermined temperature, fluid is passed to the heating element 181 as illustrated by directional arrow 234. Fluid is passed through the control valve 230 through the conduit 182 into the fin tube 180. Fluid enters the fin tube 180 at the inlet 182 of the fin tube. The fluid passes through the U-shaped 184 fin tube. The fin tube 180 includes a plurality of fins external to the fin tube so as to maximize heat exchange. The fin tube is placed over or on top of a catalytic converter 160. As heat from the catalytic converter 160 rises, the fin tube and fins 182 are heated thereby also heating the fluid passing through the fin tube 180. The catalytic converter 160 in the present invention is a standard catalytic converter having a first end 162 and a second end 164. The catalytic converter 160 is mounted to the vehicle by means of mounting brackets 168, 170, 172, 174. It is commonly known for a catalytic converter 160 to emit large amounts of heat, which heat is typically wasted. The fin tube 180 and corresponding fins 182 absorb said heat from the catalytic converter and transfer said heat to the fluid passing through the fin tube.

The fin tube 180 is placed above the catalytic converter 160 in close proximity to the catalytic converter 160. In an alternative embodiment, the fin tube 180 is in contact with the catalytic converter 160 so as to maximize heat transfer. However, the present invention also covers the concept of the fin tube 180 in close proximity to the catalytic converter 160 so as to maximize heat transfer from the catalytic converter 160 to the fin tube 180 and therefore into the fluid passing through the fin tube 180.

In the present embodiment a plurality of heat shields 190a, 190b are utilized to concentrate and direct heat from the catalytic converter 160 to the fin tube 180. The heat shields 190a, 190b are utilized to prevent any loss of the heat from the catalytic converter 160.

As the fluid flows through the fin tube 180 it then exits the fin tube 180 at an outlet 184 of the fin tube 180. Fluid then flows through a conduit 142 and through a connector 140. The connector 140 connects the conduits 142 and 138. The fluid then flows through the conduit 142 through the connector 140 and through the conduit 138 to the fluid delivery system 100. In the present embodiment, the fluid delivery system 100 includes a separator connector 134 operable to separate fluid and direct fluid to the conduits 132a and 132b. The conduits 132a, 132b then direct the heated fluid through the spray nozzles 130a, 130b. The water is pumped through the spray nozzles 130a, 130b onto the windshield 110 as shown by reference numeral 112.

If the thermostat 236 determines that the ambient temperature is above the predetermined temperature, then the fluid from the reservoir 200 bypasses the heating element 181 and is directed directly to the spray system 100. Fluid is pumped out of the reservoir 200 through the conduit and connector 210 through the conduit 214 and up through the conduit 184. This fluid flow is illustrated by directional arrow 232 illustrating the fluid flow from the conduit 214 to the conduit 184. Fluid then passes through the connector 140 and through the conduit 138 to the fluid delivery system 100. Fluid is then separated by means of the connector 134. Fluid flows respectively through the conduits 132a, 132b to the spray nozzles 130a, 130b. Fluid 112 is then sprayed onto the windshield 110.

The present embodiment illustrates the heating element as a fin tube. The heating element 181 is preferably a fin tube 180. The fin tube 180 is constructed of a heat conductive material such as aluminum. The fin tube may be of any suitable shape, but in the preferred embodiment the tube forms a U shape 184. A plurality of fins 180 extend outwardly from the tube 180. The fin tube 180 is mounted to an outer surface of the vehicle's catalytic converter 160. In an alternative embodiment, the fin tube is mounted to the vehicle and not to the catalytic converter 160.

In an alternative embodiment, the directional valve or control or control valve 230 may also be manually controlled by a switch mounted in the cabin of the vehicle 102 to permit the driver to heat wiper fluid for cleaning when the ambient or external temperature is greater than the predetermined temperature as controlled by the thermostat 236. Further, the control valve 230 may be a motor or other equivalent mechanism operable to direct fluid flow.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A wiper fluid assembly for use in a vehicle, the vehicle having a windshield, the assembly comprising:
a tubular member disposed adjacent a catalytic converter;
a reservoir holding a supply of wiper fluid;
a pump for delivering a portion of the supply of wiper fluid to the tubular member; and
a control operable to direct fluid from reservoir through the tubular member to the windshield to be heated by the catalytic converter.

2. The assembly of claim 1 wherein the tubular member is U-shaped.

3. The assembly of claim 1 wherein the tubular member includes a plurality of fins to aid in heat absorption.

4. The assembly of claim 1 wherein at least one heat shield disposed adjacent the catalytic converter to prevent heat loss and direct heat flow.

5. The assembly of claim 4 wherein two heat shields are provided positioned adjacent the catalytic converter.

6. The assembly of claim 1 wherein the control further includes a thermostat operable to measure ambient temperature.

7. The assembly of claim 6 wherein the control is programmed to direct wiper fluid to the tubular member when the thermostat reads at or below a predetermined temperature.

8. The assembly of claim 7 wherein the predetermined temperature is between 30-50° F.

9. The assembly of claim 6 wherein the control is programmed to direct wiper fluid directly to the windshield when the thermostat reads at or above a predetermined temperature.

10. The assembly of claim 9 wherein the predetermined temperature is between 30-50° F.

11. The assembly of claim 1 wherein the control is a directional valve having a first inlet, a first outlet and a second outlet.

12. The assembly of claim 9 wherein the first inlet receives wiper fluid from the reservoir.

13. The assembly of claim 9 wherein the first outlet directs wiper fluid directly from the reservoir to the fluid delivery system.

14. The assembly of claim 9 wherein the second outlet directs wiper fluid to the tube.

15. The assembly of claim 1 wherein the tube is made of a highly conductive material.

16. The assembly of claim 3 wherein the fins on the tube are made of a highly conductive material.

17. The assembly of claim 1 wherein the tube is positioned above and in close proximity to the catalytic converter.

18. The assembly of claim 1 wherein the tube is positioned to touch the catalytic converter.

19. The assembly of claim 1 wherein the wiper fluid is delivered to the windshield by means of a spray nozzle operable to spray wiper fluid on a windshield of a vehicle.
